(19) United States
(12) Patent Application Publication
(10) Pub. No.: US 2015/0128623 A1
(43) Pub. Date: May 14, 2015

(54) METHODS OF MAKING AND USING AN AIRFOIL IN A BLAST FREEZER AND BLAST FREEZER EMPLOYING THE AIRFOIL

(71) Applicant: COLD CHAIN, LLC, Boise, ID (US)

(72) Inventors: Daniel Mark Aragon, Meridian, ID (US); Peter James Wachtell, Boise, ID (US)

(73) Assignee: COLD CHAIN, LLC, Boise, ID (US)

(21) Appl. No.: 14/075,396

(22) Filed: Nov. 8, 2013

(51) Int. Cl. A23L 3/36

(52) U.S. Cl. CPC A23L 3/361
USPC 62/89; 62/407; 62/380; 29/407.01

(57) ABSTRACT

A method for adjusting pressure at an inlet of a blast freezer. The method includes positioning an airfoil proximate to the inlet, the inlet having a perimeter. The airfoil includes a strip of material having a length and being attached to the freezer along at least one side of the inlet, the strip of material being spaced from the perimeter of the inlet by an offset distance. The offset distance at any location along the length of the strip of material is the closest distance between the strip of material and the perimeter at that location. The offset distance varies substantially along at least a portion of the strip of material. Cold air is flowed in the blast freezer past the inlet and over the airfoil so that the flow of air past the inlet is disrupted and creates a resultant adjustment to the air pressure at the inlet.

### DETAILED DESCRIPTION

1. Field of the Disclosure

The present disclosure is directed to a method of employing an airfoil in a continuous flow blast freezer, and a freezer employing the airfoil.

2. Background

Many methods are commonly used for preserving foodstuffs, including canning, salting, drying, retort pouching, smoking and freezing. However, all of these methods substantially alter the taste and texture of the preserved foodstuff that typify freshness, except freezing. Freezing can maintain the freshness of food, medical specimens and other items for extended periods of time and can be considered the preferred method of long term preservation for almost all comestibles, particularly seafood, meat, fruit, vegetables and baked goods. Blast freezing systems designed for freezing large quantities of comestibles in a relatively short amount of time are known. Such systems work by subjecting the comestibles to air chilled to very low temperatures, such as −40° F., for a period of time sufficient to completely freeze the product.

The process of freezing unavoidably changes the food product chemically, biologically and physically. The magnitude of these changes, and the resulting quality of the frozen food product, is greatly affected by many factors, including the rate, method and temperature of the freezing process, and the temperature and air quality during freezing and storage. Generally speaking, it is accepted that fast freezing rates and consistently low storage temperatures are necessary for high quality in most frozen food products. Fast freezing rates create smaller ice crystal formation and less migration of compounds that remain soluble during the freezing process, which greatly affects the taste and texture of the resulting frozen product. Depending on the type of foodstuff, some compounds continue to migrate after the product is considered frozen, further altering the taste and texture. Although recommended storage temperatures vary for different products, consistent low temperatures of −20° F. to −40° F. or lower reduce this migration to nil and are considered necessary for the high quality long term storage of most frozen food. Blast freezing systems have been developed to freeze foodstuffs at these temperatures quickly.

Blast freezing systems generally consist of moving air that has been cooled to very low temperatures (often between −10° F. and −40° F.) at high volumes and high velocity past the food that is to be frozen. The super cooled air in conjunction with the high air velocity creates a fast freezing effect that allows the food product to be frozen in a short period of time.

Blast freezers are generally categorized into one of two different types based on their design. For food freezing processes that are conducted in relatively smaller batches, a closed blast freezer system may be utilized. In a closed blast freezer, the food is brought into the freezer and the door is closed, allowing the super cooled air to be circulated within the blast freezer until the food is properly cooled and frozen. The advantage of a batch type blast freezer is that the frost that is created (when humid air that enters the freezer is condensed and frozen) can be cleaned off at the end of each batch cycle. In addition, blast cycles can be run until the food product is appropriately frozen which allows for variation in the seasonality, food product being frozen, quality and efficiency of the refrigeration coils and their ability to transfer heat loads from the food to the blasted air. The disadvantage of the use of a batch blast freezing systems is that they can only be applied to relatively small batches of processed food and the entire batch must be frozen together without regard to the time at which it was cooked or created. This means that in a large processing operation, some food sits and waits for the blast freezing process to start while additional food is cooked and enters the blast freezer in a relatively fresh state. Such differences in timing between when a food is processed to when it is frozen can result in inconsistent food product.

Continuously operated blast freezers are an alternative to batch blast freezing systems. In such systems, cooked food that is ready to be frozen is fed at a relatively constant rate into an enclosed space in which super cooled air is circulated at rapid speeds. The enclosed areas can be in the form of, for example, a long tunnel, or they can be constructed in a spiral shape allowing the food to be moved by conveyor upwards or downwards to create a long distance of travel in the cold blasted air. Quality control for such blast freezers is dependent upon the temperature of the blast air and the time spent in the freezer tunnel. The conveyor may be sped up or slowed down to ensure that the quality of the frozen product remains relatively constant at the end of the freezing process. The downside to a continuous freezer process is that if the heat loads being carried into the freezer exceed the ability of the refrigeration coils to remove that heat load, the frozen product that leaves the continuous blast freezer with not be in the proper specifications. Prior to such a product quality failure, the entire blast freezer must be stopped while maintenance is performed to allow for product quality to be maintained.

Such maintenance most often involves reducing or eliminating the frost that has built up on the refrigeration coils and the frost that can build up on the conveyor systems and the walls and ceiling of the blast freezer tunnel itself. In actual continuous blast freezing systems, it is not unusual to have work stoppages occur up to eight times each day to allow for frost removal and defrost cycles to be completed.

Frost is much more prevalent in the operation of continuous blast freezers for the simple reason that in order to move food into the freezer system via conveyor, the freezer enclosure must have an opening through which the food is conveyed during freezer operations. Often the room from which the food is conveyed contains cooking equipment, such as fryers, ovens and so forth, in which the food has been cooked and otherwise processed. Therefore, these rooms are often both warm and humid. Water vapor from the warm, humid air from these rooms travels into the blast freezer along with the food to be frozen. This water vapor condenses in the cold environment of the freezer and is the source of the water that becomes frost. The infiltration problem is exacerbated by the high velocity air circulated inside of the freezer, which speeds the freezing process. This high velocity air creates a “venturi effect” at the conveyor opening which exponentially increases the warm air infiltration via the conveyor opening.

There are several types of equipment that have been created in an attempt to minimize this problem. They range from the creation of a antechamber in which the air is treated by dehumidifiers to reduce the content of water vapor that is carried into the blast freezer, to the use of specialized vestibules in which low pressure zones are created to remove the water vapors carried with the food product prior to its entry in the blast freezer. In each of these cases, there must be room between the cooking of the food and the transport of the food into the blast freezer.

Another solution involves blowing hot air at the conveyor openings or at the areas in which frost builds up in an attempt to reduce the time required to conduct a defrost cycle and maintenance exercise. The use of hot air blowers, heat tape and other devices uses energy and also has the effect of creating an additional heat load within the freezer that must be overcome by the refrigeration units. As a result, these types of solutions can have the effect of reducing the overall refrigeration capacity of the freezer systems. In addition, the problem is compounded by the physics involved.

In particular, cold air moving at high velocity past the conveyor opening has the effect of suctioning significant amounts of air from the adjacent room through the opening. This suctioning effect is caused by what is sometimes referred to in physics as the Venturi effect. The volume or air that is brought through the opening and the force with which it is sucked can have the effect of overwhelming any of the current systems that are used to try to combat the frost build up in the blast freezers. Thus, the high velocity cold air flow that is used to make a blast freezer effective also exacerbates the moisture infiltration problems that lead to frost build up in a continuous blast freezer.

### SUMMARY

An embodiment of the present disclosure is directed to a method of manufacturing an airfoil for use in a blast freezer. The method comprises determining the shape and position of an airfoil that will disrupt the flow of air so as to adjust air pressure at an inlet of a blast freezer. Material from which the airfoil can be made is provided. The material is formed into the determined shape.

Another embodiment of the present disclosure is directed to a method for adjusting pressure at an inlet for introducing product into a blast freezer. The method comprises positioning one or more airfoils proximate to the inlet. Cold air in the blast freezer is flowed past the inlet and over the one or more airfoils so that the flow of air past the inlet is disrupted and creates a resultant adjustment to the air pressure at the inlet.

Yet another embodiment of the present disclosure is directed to a continuous flow blast freezer. The blast freezer comprises an inlet configured to allow entry of product to be frozen. A cooling mechanism is configured to provide a flow of cold air through the blast freezer. An airfoil is positioned proximate the inlet.

It is to be understood that both the foregoing general description and the following detailed description are exemplary and explanatory only and are not restrictive of the present teachings, as claimed.

### BRIEF DESCRIPTION OF THE DRAWINGS

The accompanying drawings, which are incorporated in and constitute a part of this specification, illustrate embodiments of the present teachings and together with the description, serve to explain the principles of the present teachings.

FIG. 1 shows a flowchart of method for adjusting pressure at an inlet of a blast freezer, according to an embodiment of the present disclosure.

FIGS. 2A to 2C show different views of an airfoil, according to an example of the present disclosure.

FIG. 3 illustrates another example of airfoil comprising two separate pieces, according to an embodiment of the present disclosure.

FIGS. 4 to 9 show modeling data for blast freezer inlets both with and without airfoils, as discussed in the examples of the present disclosure.

FIG. 10 shows a flowchart of a method of manufacturing an airfoil for use in a blast freezer, according to another embodiment of the present disclosure.

It should be noted that some details of the figure have been simplified and are drawn to facilitate understanding of the embodiments rather than to maintain strict structural accuracy, detail, and scale.

### DESCRIPTION OF THE EMBODIMENTS

Reference will now be made in detail to embodiments of the present teachings, examples of which are illustrated in the accompanying drawings. In the drawings, like reference numerals have been used throughout to designate identical elements. In the following description, reference is made to the accompanying drawing that forms a part thereof, and in which is shown by way of illustration a specific exemplary embodiment in which the present teachings may be practiced. The following description is, therefore, merely exemplary.

The inventors of the present disclosure have found that the use of an airfoil that is appropriately shaped and placed within a blast freezer can offset a low pressure zone caused by high velocity airflows at a conveyor inlet, and thereby reduce an associated influx of undesirable moisture into the freezer. An airfoil can be shaped similar to a wing or have any other suitable shape that can create areas of high pressure and low pressure on either side of the airfoil. If such an airfoil is placed in a fixed position in a blast freezer, a pressure zone across the conveyor inlet of the blast freezer can be tuned to have a pressure similar to the pressure of the ambient air outside of the blast freezer. The net result is reduced influx of air and moisture into the blast freezer through the conveyor inlet.

Airfoil shapes and their effect on pressure gradients at the blast freezer inlet can be modeled using available airflow dynamics software. The results of using an appropriately engineered airfoil in the blast freezer is that defrost cycles can be reduced significantly without taking up space outside of the blast freezer and/or without expending significant energy to address the problem.

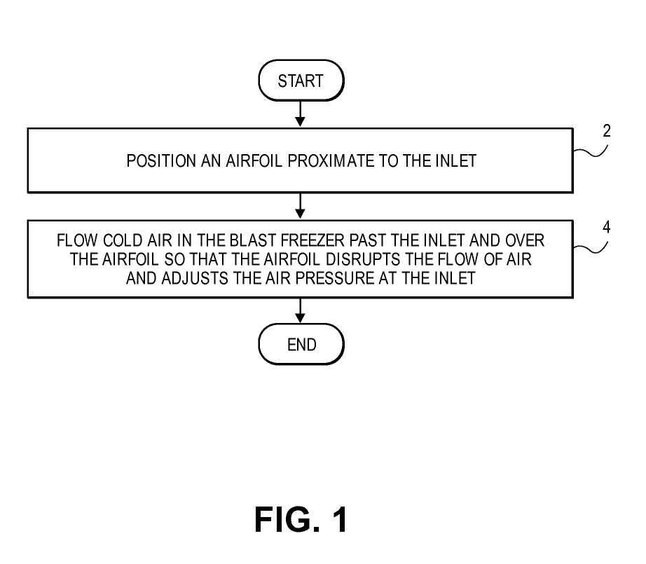

FIG. 1 shows a flowchart of method for adjusting pressure at an inlet of a blast freezer, according to an embodiment of the present disclosure. The method comprises positioning an airfoil proximate to the inlet of the freezer, as shown at 2 of FIG. 1. The inlet of the blast freezer can be used for introducing product into the freezer in a continuous manner, as is generally well known in the art. For example, a conveyor belt or other means for transporting product to be frozen can enter the blast freezer through the inlet.

As shown at 4 of FIG. 1, cold air in the blast freezer flows past the airfoil so that the airfoil disrupts the flow of air and thereby adjusts the air pressure at the inlet. In an embodiment, the air flowing over the airfoil reduces a pressure gradient between the air inside the freezer and the air outside the freezer proximate the inlet, compared to the pressure gradient that would otherwise exist without the airfoil, given the same air flow velocities inside the freezer. In an embodiment, the pressure gradient across the inlet can be reduced sufficiently so as to substantially equalize the air pressure, thereby significantly reducing flow of moisture carrying gasses into the freezer.

The airfoil can have any suitable shape and be any suitable size that will provide the desired reduction in pressure gradient across the freezer inlet. In an embodiment, the airfoil is a strip of material attached to the freezer along at least one side of the inlet.

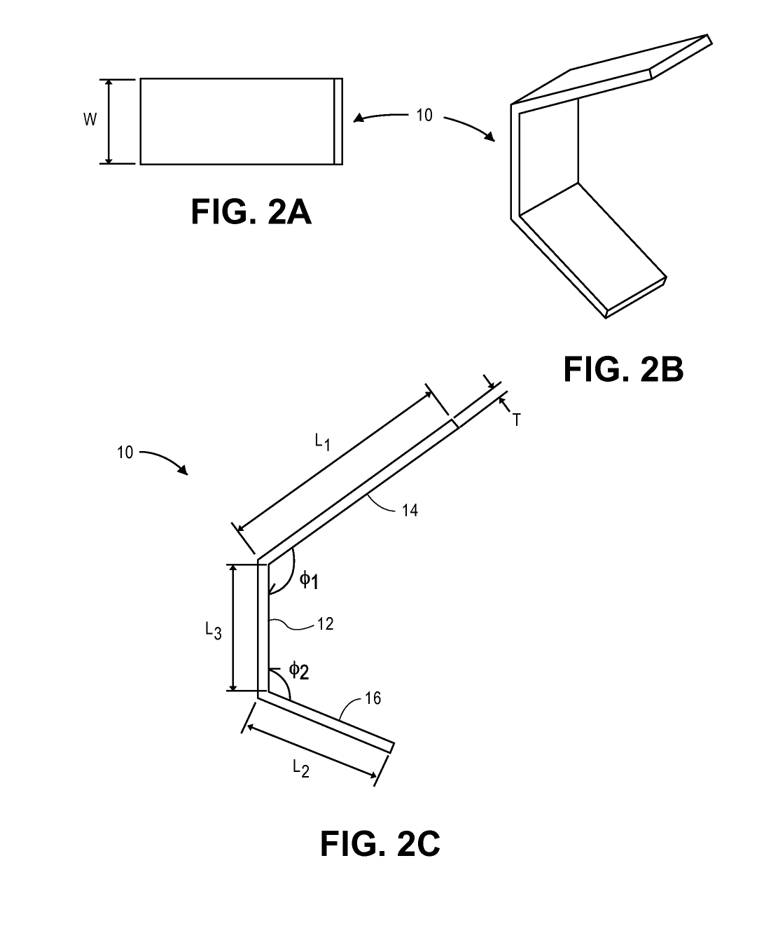

An example of an airfoil 10 is shown in FIGS. 2A to 2C. Airfoil 10 comprises a strip of material, such as metal or plastic. The strip of material comprises a mid-portion 12, a first end portion 14 and a second end portion 16. The first end portion 14 has a length, L₁, and is angled at a first angle, φ₁, with respect to the mid-portion 12. The second end portion 16 has a length, L₂, and is angled at a second angle, Φ₂, with respect to the mid-portion 12.

L₁ and L₂ can be the same or different. In an embodiment, L₁ is longer than L₂. In other embodiments, L₂ can be longer than L₁. Similarly, φ₁ and φ₂ can be the same or different. In an embodiment, φ₁ is greater than φ₂. In other embodiments, φ₂ can be greater than φ₁. In an embodiment, the mid-portion 12 has a length, L₃, that is about as long as, or longer than, a side of the inlet of the freezer most proximate to which airfoil 10 is positioned.

The airfoil 10 can have any suitable dimensions that will provide the desired effect on the pressure gradient at the freezer inlet, as described herein. Suitable dimensions for L₁, L₂ and L₃ can range, for example, from about 10 inches to about 100 inches, or about 15 inches to about 60 inches, or about 20 inches to about 50 inches. In an embodiment, the ratio of L₁ to L₂ can range from about 1:1 to about 5:1, such as about 3:2 to about 3:1, or about 2:1. In an embodiment, φ₁ and φ₂ can range, for example, from about 90° to about 180°, such as about 100° to about 120° or 150°. Suitable dimensions for W can range, for example, from about 1 inch to about 3 feet, or about 10 inches to about 2 feet, or about 12 inches to about 20 inches. Suitable dimensions for T can range, for example, from about 0.1 inch to about 6 inches, or about 0.5 inches to about 3 inches, or about 1 inch to about 2.5 inches. The dimensions can range widely depending on such variables as the dimensions of the freezer inlet and airflow velocities in the freezer. Dimensions outside of the above ranges can be employed.

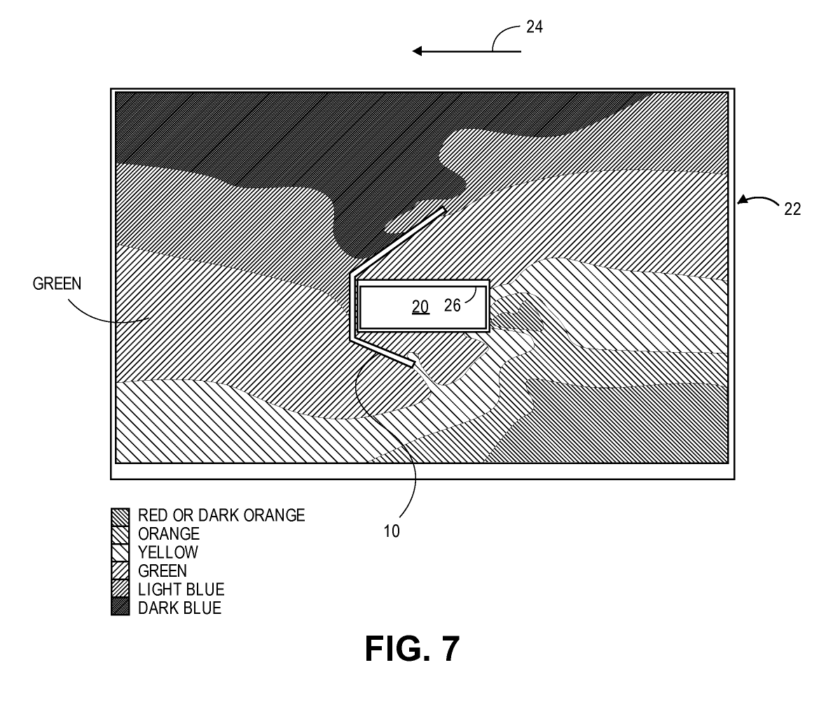

The airfoil 10 can be positioned in any suitable manner with respect to the inlet that will provide the desired reduction in pressure gradient at the inlet. For example, airfoil 10 can be positioned up-flow of the inlet, down-flow of the inlet, above or below the inlet, or around part or all of the inlet perimeter. FIG. 7 shows an example of an airfoil 10 positioned proximate to a blast freezer inlet 20. In FIG. 7, the airfoil 10 is positioned down-flow of the inlet and extends around a portion of the inlet perimeter.

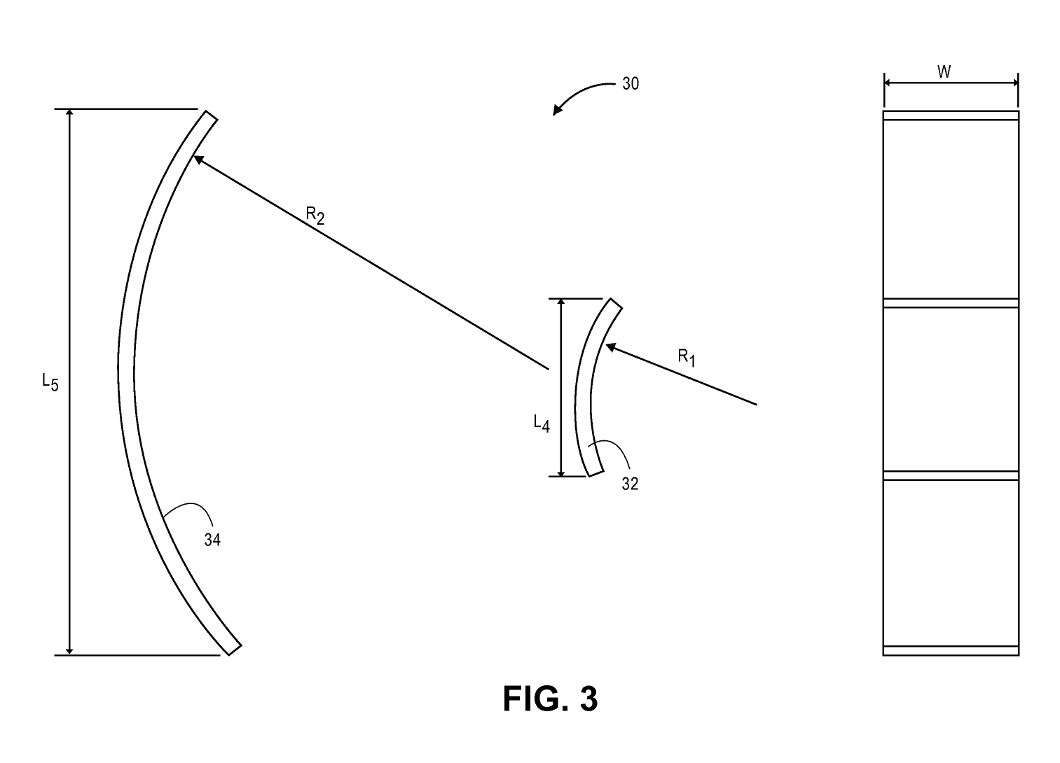

FIG. 3 illustrates an example of an airfoil comprising two separate pieces. A first piece 32 is configured to be positioned on a first side of the inlet. A second piece 34 is configured to be positioned on the side of the inlet opposite the first piece 32. First piece 32 has a radius of curvature, R₁, and a length dimension, L₄. Second piece 34 has a radius of curvature, R₂, and a length dimension, L₅.

The airfoil 30 can have any suitable dimensions that will provide the desired effects for the airfoil, as described herein. Suitable dimensions for L₄ can range, for example, from about 10 inches to about 50 inches, such as about 15 inches to about 40 inches, or about 20 inches to about 30 inches. Suitable dimensions for R₁ can range, for example, from about 10 inches to about 50 inches, such as about 15 inches to about 40 inches, or about 20 inches to about 30 inches. Suitable dimensions for L₅ can range, for example, from about 30 inches to about 100 inches, such as about 40 inches to about 90 inches, or about 50 inches to about 80 inches. Suitable dimensions for R₂ can range, for example, from about 30 inches to about 100 inches, such as about 40 inches to about 90 inches, or about 50 inches to about 70 inches. Suitable dimensions for W can range, for example, from about 1 inch to about 3 feet, or about 10 inches to about 2 feet, or about 12 inches to about 20 inches.

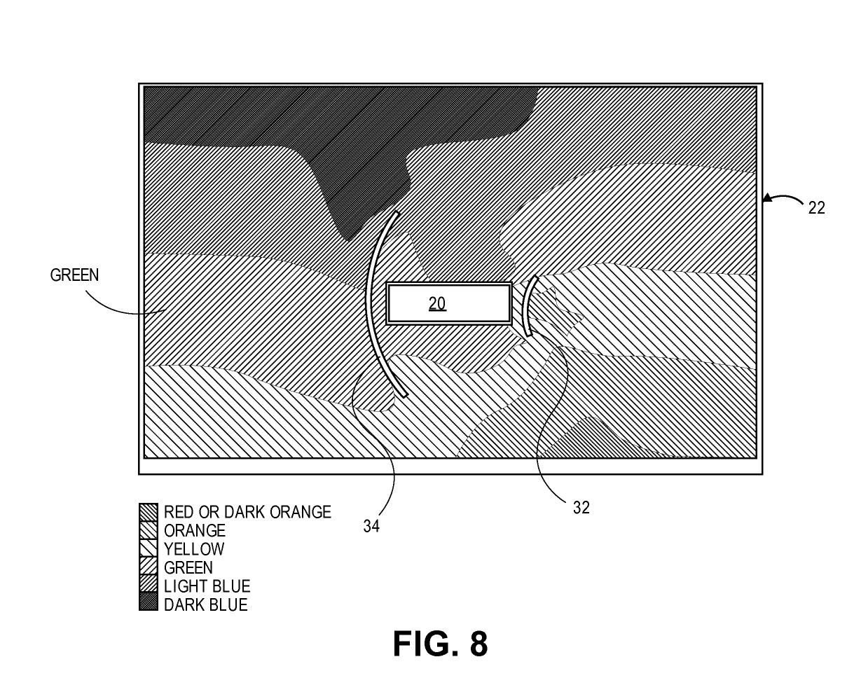

FIG. 8 illustrates an example in which first piece 32 is positioned upstream of the inlet 20, second piece 34 is positioned downstream of the inlet 20, and R₁ is smaller than R₂. However, other embodiments are contemplated, such as where R₁ is larger than R₂.

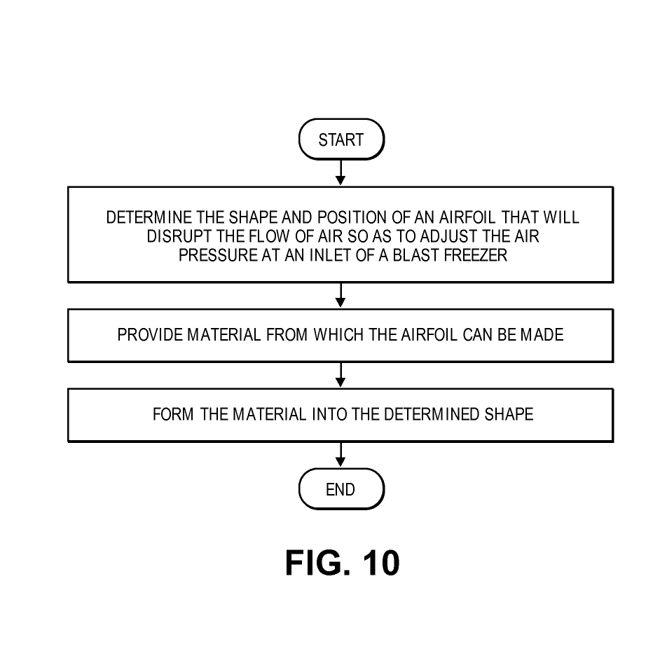

FIG. 10 shows a flowchart of a method of manufacturing an airfoil for use in a blast freezer, according to an embodiment of the present disclosure. The method comprises determining the shape and position of an airfoil that will disrupt the flow of air so as to adjust the air pressure at an inlet of a blast freezer. Determining the shape and position of the airfoil can include, for example, determining the direction and velocity of air flow at the inlet of the blast freezer and/or determining the dimensions of the inlet. Such information can be employed as inputs into the software used to model effects of a given airfoil design on pressure and airflows in the blast freezer and to determine a desired shape for the airfoil. As discussed above, a desired shape for the airfoil can reduce pressure gradients and/or equalize pressure proximate the inlet between the air inside the freezer and the air outside the freezer during freezer operation.

After a desired airfoil shape has been determined, a material from which the airfoil can be made is then formed into the desired shape. Any suitable material can be employed. Examples of suitable materials include stainless steel, galvanized steel, molded carbon fiber, fiberglass and epoxy resin and various types of plastic that are stiff enough to adequately deflect the moving air without changing their shape in a material manner.

Any suitable method can be used to fabricate the airfoil from the material. Examples of suitable methods for fabricating the airfoil are well known in the art and are highly dependent upon which of the above materials are used for creating the airfoil with the desired shape and size.

Another embodiment of the present disclosure is directed to a continuous flow blast freezer comprising airfoils, as described herein. The continuous flow blast freezer comprises an inlet configured to allow entry of product to be frozen and a cooling mechanism configured to provide a flow of cold air through the blast freezer. Any suitable continuous blast freezer and cooling mechanism can be employed. Suitable blast freezers and cooling mechanism are well known in the art. In an embodiment, the continuous flow blast freezer includes a conveyor for transporting the product through the blast freezer.

The airfoil is positioned in the freezer proximate the inlet as discussed herein. Any suitable technique can be employed for attaching the airfoil to the freezer. Examples of such techniques are also well known in the art.

### EXAMPLES

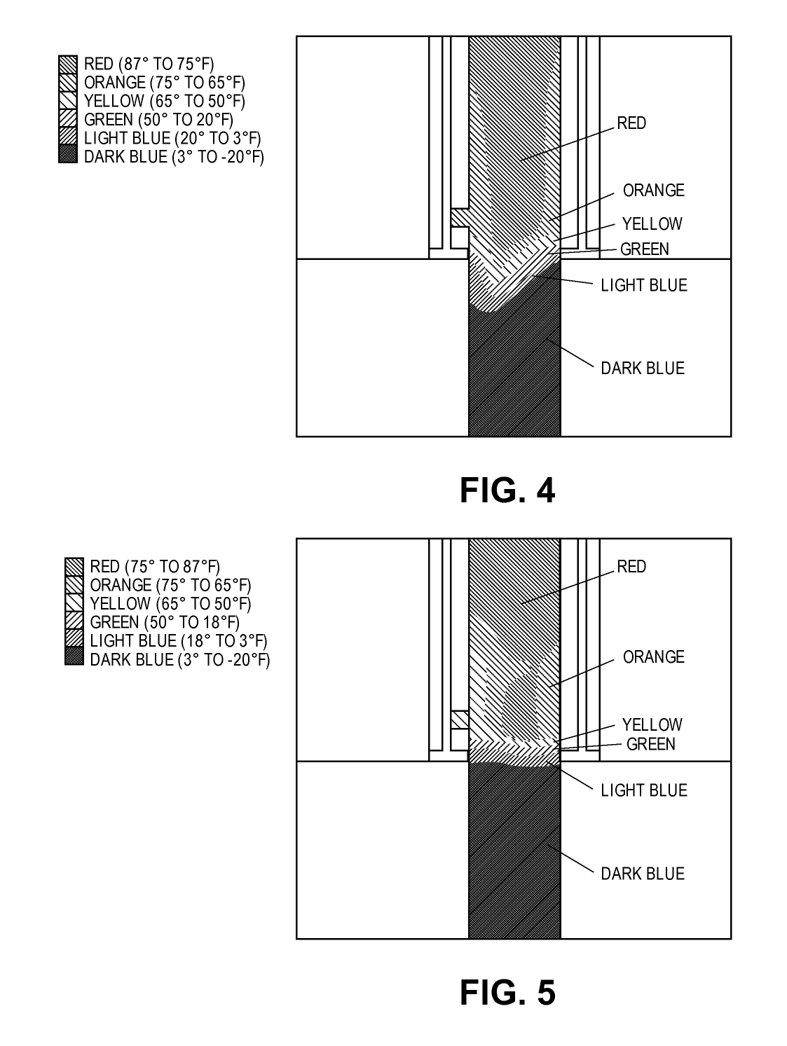

Modeling of the airfoil in a blast freezer was carried out using the Computational Fluid Dynamics module of SOLIDWORKS software available from Dassault Systems of Boston, Massachusetts. Color plots showing temperature and pressure data results were made, with the gradients in temperature or pressure represented by variations in color. FIGS. 4 to 7 are black and white representations of these color plots, with different colors represented by different hatched regions in the figures, as set forth in the key. The hatched regions, as well as the pressure ranges listed in the key for each hatched region, are not exact replications of the color plots, but are merely approximations made for the purpose of showing the patent illustrations in black and white.

FIGS. 4 and 5 are black and white approximations of the temperature gradients based on data shown in the color plots for a computer simulation of air temperatures at the inlet of a blast freezer in operation. The keys of FIGS. 4 and 5 show hatch marks representing various temperature ranges. The lowest temperatures are represented by hatch marks labeled dark blue; and the highest temperatures are represented by hatch marks labeled red, with intermediate temperature ranges being represented by hatch marks for light blue, green, yellow and orange areas from the color plots.

FIG. 4 shows the results of a simulation of a conveyor inlet opening into a blast freezer without an airfoil, from a view looking down from above the opening. The hatched rectangle at the top, with the hatch showing mostly red, simulates a conveyor carrying hot foods downwards towards the blast freezer opening. Once inside the freezer, all of the air is rapidly cooled to a temperature below freezing, as shown by the dark blue labeled hatch.

As can be seen in FIG. 4, there is a conical intrusion of warm air that reaches through the inlet into the blast freezer. The warm air, which would carry significant moisture, is blown into the freezer and cooled by the much larger volume of frozen air that is being blown at high speed across the opening. In this figure, the blast freezer air is being blown from the right side to the left side of the simulation. The result is that the cone of warm air is deformed and pushed to the left side of the opening, where the warm air of the cone is abated and flows into the larger volume of the blast freezer.

FIG. 5 shows the results of a simulation of the same blast freezer inlet as in FIG. 4, with the same temperature inputs, but with the included placement of a an airfoil in the blast freezer similar to the airfoil 10 of FIG. 7. FIG. 5 is a view looking at the conveyor opening into the blast freezer from above the opening looking down.

The simulation shows that the result of the use of the airfoil is that there is very little warm air that enters into the blast freezer through the conveyor opening. As a result, there would be a significant reduction in moisture entering the blast freezer.

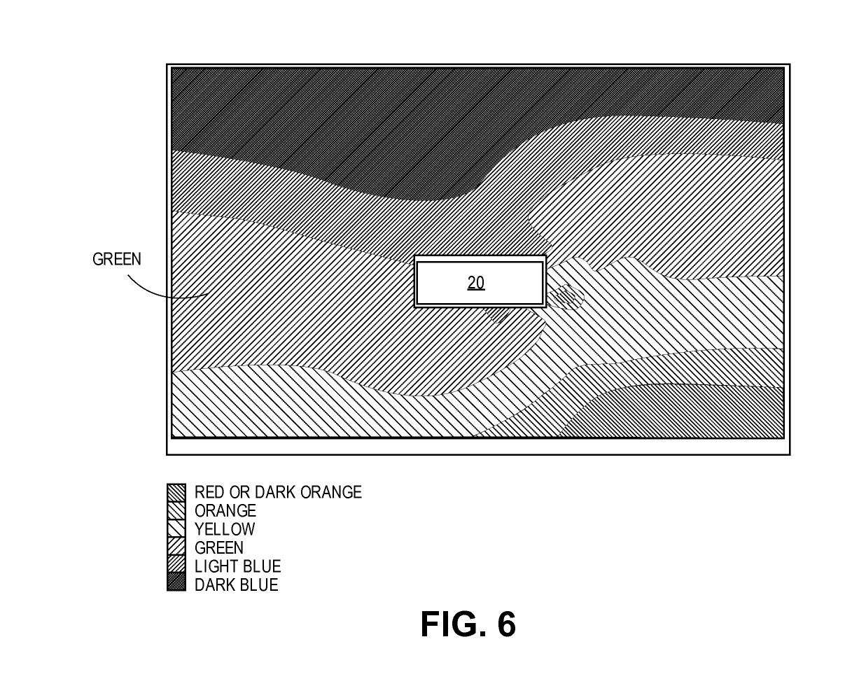

FIGS. 6 and 7 are black and white approximations of the pressure gradients based on data shown in color plots of a computer simulation of an inlet of a blast freezer in operation. In the case of FIG. 6, there was no airfoil used to change or control the air pressures across the opening. In the case of FIG. 7, an airfoil was used.

The keys of FIGS. 6 and 7 show hatch marks representing various pressure ranges. The lowest pressures are represented by hatch marks labeled dark blue; and the highest pressures are represented by hatch marks labeled red, with intermediate pressures ranges being represented by hatch marks for light blue, green, yellow and orange areas from the color plots.

The hatched area labeled green in these figures represents a middle grade of pressure that is the equalized pressure of the atmosphere both inside and outside the blast freezer. In FIG. 6, one can see the relatively high pressures on the right side of the opening that shows outside air moving swiftly into the freezer through the opening when no airfoil is used.

FIG. 7 shows a well shaped and well placed airfoil 10 used to change or control the air pressures across the opening. One can see the hatch across the opening is nearly entirely labeled green in color, indicating that a median pressure equal to the pressure of the air outside the blast freezer is being maintained across the opening itself. The result is that there is a reduced amount of air from outside of the blast freezer that is being either pushed out or pulled into the freezer.

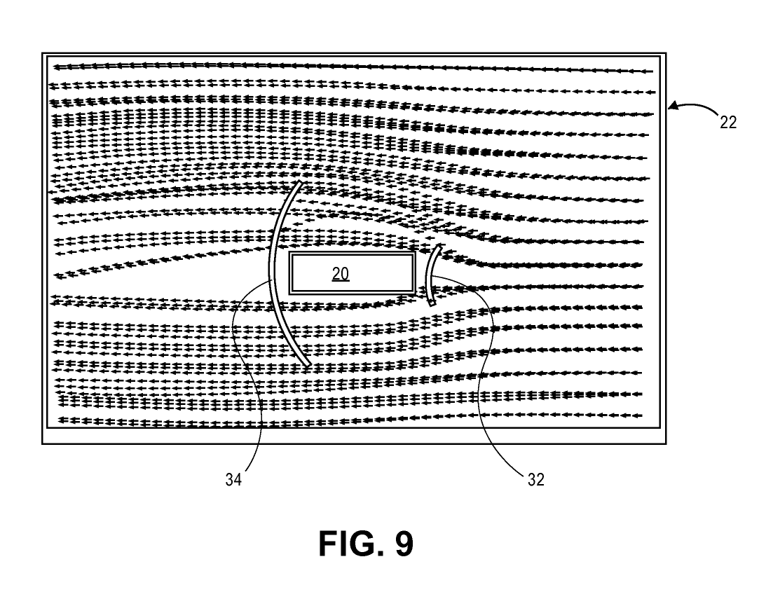

FIG. 8 shows pressure data as simulated for a two piece airfoil design used to change or control the air pressures across the opening of a blast freezer. One can see the hatch across the opening is largely labeled green in color, indicating a median pressure equal to the pressure of the air outside the blast freezer is being maintained across much of the opening. The result of this is that there is a reduced amount of air from outside of the blast freezer that is being either pushed out or pulled into the freezer. FIG. 9 shows an example of the disruption in the pre-existing airflows that occurs as a result of the placement of an airfoil in the blast freezer airflow relative to the freezer opening.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein.

While the present teachings have been illustrated with respect to one or more implementations, alterations and/or modifications can be made to the illustrated examples without departing from the spirit and scope of the appended claims. In addition, while a particular feature of the present teachings may have been disclosed with respect to only one of several implementations, such feature may be combined with one or more other features of the other implementations as may be desired and advantageous for any given or particular function. Furthermore, to the extent that the terms “including,” “includes,” “having,” “has,” “with,” or variants thereof are used in either the detailed description and the claims, such terms are intended to be inclusive in a manner similar to the term “comprising.” Further, in the discussion and claims herein, the term “about” indicates that the value listed may be somewhat altered, as long as the alteration does not result in nonconformance of the process or structure to the illustrated embodiment. Finally, “exemplary” indicates the description is used as an example, rather than implying that it is an ideal.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompasses by the following claims.

1-8. (canceled)

9. The method of claim 24, wherein the flowing the air over the airfoil reduces a pressure gradient between the air inside the freezer and air outside the freezer proximate the inlet relative to the pressure gradient that would exist given the same flow of air without the airfoil.

10. The method of claim 24, wherein the airfoil is positioned so as to be down flow of the cold air at the inlet when the freezer is in operation.

11. The method of claim 24, wherein the airfoil is positioned so as to be up flow of the cold air at the inlet when the freezer is in operation.

12. (canceled)

13. (canceled)

14. The method of claim 24, wherein the length of the strip of material is longer than one side of the inlet.

15-22. (canceled)

23. (canceled)

24. A method for adjusting pressure at an inlet of a blast freezer, the method comprising:
positioning an airfoil proximate to the inlet, the inlet having a perimeter, the airfoil comprising a strip of material having a length and being attached to the freezer along at least one side of the inlet, wherein the strip of material comprises a mid-portion, a first end portion attached to the mid-portion and a second end portion attached to the mid-portion, the first end portion having a first length and being angled at a first angle with respect to the mid-portion, the second end portion having a second length and being angled at a second angle with respect to the mid-portion, wherein the first angle and the second angle range from about 100° to about 150°; and
flowing cold air in the blast freezer past the inlet and over the airfoil so that the flow of air past the inlet is disrupted and creates a resultant adjustment to the air pressure at the inlet.

25. (canceled)

26. The method of claim 29, wherein the first radius of curvature is larger than the second radius of curvature.

27. The method of claim 29, wherein the first radius of curvature is smaller than the second radius of curvature.

28. (canceled)

29. A method for adjusting pressure at an inlet of a blast freezer, the method comprising:
positioning an airfoil proximate to the inlet, the inlet having a perimeter, the airfoil comprising two separate pieces proximate the inlet, a first piece positioned so as to be up flow of cold air at the inlet when the freezer is in operation, and a second piece positioned so as to be down flow of the cold air at the inlet when the freezer is in operation, wherein the first piece has a first radius of curvature and the second piece has a second radius of curvature that is different than the first radius of curvature; and
flowing cold air in the blast freezer past the inlet and over the airfoil so that the flow of air past the inlet is disrupted and creates a resultant adjustment to the air pressure at the inlet.

30. The method of claim 29, wherein the first radius of curvature ranges from about 10 inches to about 50 inches.

31. The method of claim 29, wherein the second radius of curvature ranges from about 30 inches to about 100 inches.
